(19) United States
(12) Patent Application Publication
(10) Pub. No.: US 2014/0195209 A1
(43) Pub. Date: Jul. 10, 2014

(54) Counter-Example Guided Abstraction Refinement Based Test Case Generation From Simulink/Stateflow Models

(71) Applicant: GM GLOBAL TECHNOLOGY OPERATIONS LLC, Detroit, MI (US)

(72) Inventors: Manoranjan Satpathy, Bangalore (IN); Srihari Sukumaran, Bangalore (IN); Ambar A. Gadkari, Bangalore (IN)

(73) Assignee: GM GLOBAL TECHNOLOGY OPERATIONS LLC, Detroit, MI (US)

(21) Appl. No.: 13/737,237

(22) Filed: Jan. 9, 2013

(51) Int. Cl. G06F 17/50

(52) U.S. Cl. CPC G06F 17/5009
USPC 703/2

(57) ABSTRACT

A method for verifying reachability of a transition path between states with respect to Simulink/Stateflow models; (a) a concrete simulation model is generated and an abstract model is generated; (c) an abstract path is generated that is a sequence of transition steps from a start state to a target state; (d) a validity of the abstract path is checked utilizing the concrete simulation model; (e) a result is output to a user that identifies the abstract path as a reachable result; (f) partitioning a respective state of the transition step that was invalid in the abstract path; (g) recomputing a next abstract model based on partitioned start state; (h) generating an next abstract path; (i) determining whether the next abstract path is valid; (j) outputting a result to the user that identifies whether the recomputed abstract path is a valid result; otherwise proceeding to step (f).

### BACKGROUND OF INVENTION

An embodiment relates generally to verification of input and output response signals in vehicle systems.

In automobiles, numerous functional systems are handled by electronic and control software applications. Such systems utilize distributed real-time embedded software systems that require high integrity development and verification processes.

Vehicle software systems are typically created as an initial abstract model of a controller which is then validated using physical testing or formal verification and are refined iteratively. Test sequences created to test each of the software applications by their input and output responses are applied to a device, subsystem, or system utilizing an actual vehicle or test bed. Physical testing requires setup of the test bed or physical components in an actual vehicle using actual hardware required for testing or validation. Simulation provides an alternative to actual hardware and test setup, however, verification of vehicle system test models for implementation in vehicle systems is subject to the issue of state-space scalability. That is, in testing a model using simulation, scalability of testing (i.e., expansion of testing data to cover all need test cases) may increase exponentially thereby creating a very time consuming and costly process.

### SUMMARY OF INVENTION

An embodiment contemplates a method for verifying reachability of a transition path between states with respect to Simulink/Stateflow® models. (a) generating a concrete simulation model as a transition system; (b) generating an abstract model; (c) generating an abstract path that is a sequence of transition steps from a start state to a target state; (d) checking a validity of the abstract path utilizing the concrete simulation model; (e) outputting a result to a user that identifies the abstract path as a reachable result; otherwise (f) partitioning a respective state of the transition step that was invalid in the abstract path; (g) recomputing a next abstract model based on partitioned start state in step (f); (h) generating an next abstract path; (i) determining whether the next abstract path is valid in the concrete model; (j) outputting a result to the user that identifies whether the recomputed abstract path is a valid result for testing the concrete model in a vehicle system; otherwise proceeding to step (f).

### BRIEF DESCRIPTION OF DRAWINGS

FIG. 1 is an exemplary state diagram illustrating a transition in predicate form.

FIG. 2 is an exemplary state diagram of a transition system.

FIG. 3a is an exemplary state diagram of an initial abstraction.

FIG. 3b is an exemplary refined state diagram of the initial abstraction.

FIG. 4a is an initial abstraction path for a model fsa(α⁰) as Ã₀.

FIG. 4b is a refinement of the initial abstract path in FIG. 4a.

FIG. 5a is a two-state abstraction of the transition system in FIG. 2.

FIG. 5b is an abstract model obtained by refinement of FIG. 5a.

FIG. 5c is a second refinement of the abstract model of FIG. 5a.

FIG. 6 illustrates a reachability approach.

### DETAILED DESCRIPTION

The invention includes a method of verification of a reachability of transition system models. The embodiments described herein utilize a counter-example guided abstraction refinement (CEGAR) based method for checking reachability properties of Simulink® models which is a commercially available modeling tool for simulating and analyzing multidomain dynamic systems. Simulink® models are considered having underlying transition system semantics. The technique described herein is based on finite state abstractions built from partitions of state space of the transition system and the refinements of such abstractions by splitting of partitions based on an infeasible transition. The system for executing the technique as described herein utilizes at least one processor, a memory, and an output display device for outputting results to a user, a human machine interface for allowing a user to input control commands, and test device such as a test harness for checking the validity of modeled results on a hardware device. The processor may perform the following functions that include, but are not limited to, path generation, translation between a SL/SF model and a concrete model, validity checking, and model refinement.

The embodiments describe herein utilize concrete and abstract models. A transition system, represented as M, is a set of elements that include (1) a set of variables V, (2) an initial condition I, and (3) a transition relation (T).

The set of variables V include a set of input variables V_{?} and a set of output variables V_{!}; both these subsets have no element in common. Each variable υεV takes values from a domain D_{υ}. For a set of variables Z⊂V, the set of valuations of the variables in Z will be denoted by D(Z) [symbol] x_{υεz}D_{υ}. The state space of M is thus Γ [symbol] D(V).

The initial condition I is a predicate on the output variables in V. That is, I is a map:I:D(V_{!})→BOOLEAN. A valuation of variables in V_{!} is assigned the value of true provided the valuation satisfies the predicate denoting the initial state. I can also be denoted as the set of states (⊂Γ) satisfying the initial condition. Both these usages are mutually compatible.

The transition relation T is a predicate on V and V′ where V′={v′|vεV}. That is T is a map:T:D(V)xD(V)→BOOLEAN. Intuitively, for a variable υ, υ and υ′ denote the pre-transition and post-transition values of that variable. Analogous to the case with I, a set interpretation can be T⊂Γ×Γ. Valuations of the variable V are referred to as “states” in the transition system (i.e., sεΓ). This includes input variables as well as output variables. This transition relation is expressed as a disjunctive combination of guard-action pairs {(gᵢ,aᵢ)}. In general, a guard gᵢ, can be a predicate on V and V′ (i.e., gᵢ⊂Γ×Γ). An action aᵢ is a set of equation of the form v′=e(V,V′)², where vεV_{!} and each variable in V_{!} occurs exactly once on LHS, and e(V,V′) is an expression on V and V′ that evaluates to a value in domain Dᵥ. Such an action aᵢ can be translated to an equivalent predicate uᵢ on V and V′, i.e., uᵢ ⊂Γ×Γ. Refer to FIG. 1 which shows a transition in predicate form. The transition in predicate is represented by (g,u)=(v₁=v₂′ [symbol] v₂=5 [symbol] v₃=1, v₁′=5 [symbol] v₂′=v₁′+2) where V_{!}={v₁, v₂} and V_{?}={v₃}.

Valuations of the variables V are called the states of the transition system, sεΓ. Note that this includes input as well as output/internal variables. The notation s|z will refer to the projection of the state onto the set Z⊂V (i.e., it denotes the notation of the variables in Z).

A labeled trace of a transition system is a sequence s₁, l₁, s₂, l₂ . . . such that s₁εI. and ∀ⱼ≧1:Tⱼ(sⱼ, sⱼ₊₁). A trace is a sequence s₁, s₂, . . . such that ∃l₁, l₂; and s₁, l₁, s₂, l₂ . . . as a labeled trace. A labeled trace if finite length will be called a finite (labeled) trace.

M is considered deterministic if:

∀s₁,s₂,s₃εΓ:T(s₁,s₂) [symbol] s₂|v_{!}=s₃|v_{!}

M's transitions Tₗ are said to be disjoint if:

∀l₁εrange(λ),s₁,s₂εΓ:T(s₁,s₂) [symbol] Al₂εrange(λ),s₃εΓ:l₁≠l₂ [symbol] Tₗ₂(s₁,s₃) [symbol] s₂|v_{!}=s₃|v_{!}

In general, determinism and disjointness do not imply one-another. But if M is deterministic but its transitions are not disjoint, then the following holds:

∀l₁,l₂εrange(λ),s₁,s₂,s₃εΓ:Tₗ₁(s₁,s₂) [symbol] Tₗ₂(s₁,s₂) [symbol] s₂|v_{!}=s₃|v_{!}

This simplifies the process to generate a deterministic M's transitions disjoint by partitioning S based on such pairs of states that are connected by multiple Tₗₛ, and extending this partitioning to the Tₗₛ that overlap. If M is non-deterministic, a trace of it can correspond to multiple labeled traces.

The model is referred to as an automata which studies abstract machines and computational problems using abstract machines. The automata utilizes states and transitions. The automata described herein utilizes five units (Σ, S, I, δ, F), where τ is an alphabet, S is a set of states, I⊂S is the set of initial states, F⊂S is the set of final states, and δ⊂S×Σ×S is the transition relation. The automata is finite if S is finite. Derivations of the automata are defined as paths from a state in I to a state in F.

For an automata A₁=(Σ, S₁, I₁, δ₁, F₁) and A₁=(Σ, S₂, I₂, δ₂, F₂), a relation H⊂S₁×S₂ is called a simulation relation if for all (s₁, s₂)⊂H. For every transition from s₁, there is a corresponding transition from s₂, that is the following holds that for all l and s₁′ s.t., (s₁, l, s₁′)εδ₁, there exists s₂′ s.t., (s₂, l, s₂′)εδ₂ and (s₁′, s₂′)εH.

A definition (definition 3) is set such that an automation A₂ is said to be an abstraction of automation A₁, written A₂>A₁, when there exists a simulation relation H such that:
for all s₁εI₁ there exists an s₂εI₂ s.t., H(s₁, s₂), and
for all s₁, s₂ if s₁εF₁ and (s₁ s₂)εH then (s₂εF₂),
   A theorem (theorem 1) can be derived as follows: if A₂>A₁ and s₁¹, l₁, s₂¹, l₂, . . . , sₘ² (s₁¹εI₁ and sₘ¹εF₁) is a derivation A₁, then there exists a corresponding derivation s₁², l₁, s₂², l₂, . . . , sₘ², in A₂). Therefore, when A₂>A₁, A₂ is often called an existential abstraction of A₁, since any derivation of A₁ is also guaranteed to exist in A₂.

Given the automata, the transition system M, and the set of states F⊂S, a determination is made whether F is reachable in M. If F is reachable, a witness trace is returned. F will be given as a predicate on V, but F can also be denoted as a subset of S. Therefore, F is denoted as either a predicate or the corresponding set.

The objective is to find a path in a possibly infinite state automata A_{M,F}, where A_{M,F} [symbol] (range(λ), S, I, δ, F) and δ(s₁, l, s₂) [symbol] Tₗ(s₁, s₂). It should be understood that every finite labeled trace of the transition system M ending is a state in F is a path (derivation) of A_{M,F}, and vice versa.

Once the automata has been defined, the predicate abstraction of the transition system models is considered. The abstract models are a finite state automata related to A_{M,F} via ≧. To do so, assumptions are made such I≠0 and F≠0. If this were not true, then there would be no problem to solve. Secondly, I∩F≠0. If this were not true, then the problem could be trivially solved. The abstract model will be defined in terms of a set of abstract states \tilde{S} and its connection with S, which is the state space of the concrete model since abstract models are defined in terms of partitions of the state space of the concrete model.

A definition (definition 4) is set so that a partition of S is a tuple (\tilde{S}, α) such that \tilde{S} is a set and α:S→\tilde{S} is an onto map. For a partition (\tilde{S}, α) we define b:S→2^{s} as β:(\tilde{s}). Note that β(\tilde{s}) can also be expressed as a predicate on the variables V. The partition (\tilde{S}, α) will be denoted by (\tilde{S}, b).

An abstract model can be viewed as a finite state automata (FSA) that is defined in terms of partition. Given a partition (\tilde{S}, a) of S, the corresponding FSA abstract model is defined as fsa(α) [symbol] (range(λ), \tilde{S}, Ĩ, \tilde{δ}, \tilde{F}) where:

Ĩ [symbol] {\tilde{s}|β(\tilde{s}) [symbol] I}

\tilde{F} [symbol] {\tilde{s}|β(\tilde{s}) [symbol] F}

It is possible that \tilde{F}=0, which would mean that the abstraction is useless. To prevent, at least one of the elements of the partition is needed, β(s), to be such that in implies F. A natural way to achieve this is to ensure that the partition (\tilde{δ}, α) respects F (i.e., any element of the partition either contains no element from F of all the element are from F. A most simplistic way to realize this is to keep F itself as one of the partitions. As a result, \tilde{δ} captures the possibility of a transition in M such that:

\tilde{δ}(\tilde{s}₁,l,\tilde{s}₂) [symbol] ∃s₁εβ(\tilde{s}₁),s₂εβ(\tilde{s}₂):Tₗ(s₁,s₂)

As a result, the following Theorem (theorem 2) can be derived:

fsa(α⁰)≧_{α}_{⁰}_{,β}_{⁰}Ã_{M,F}.

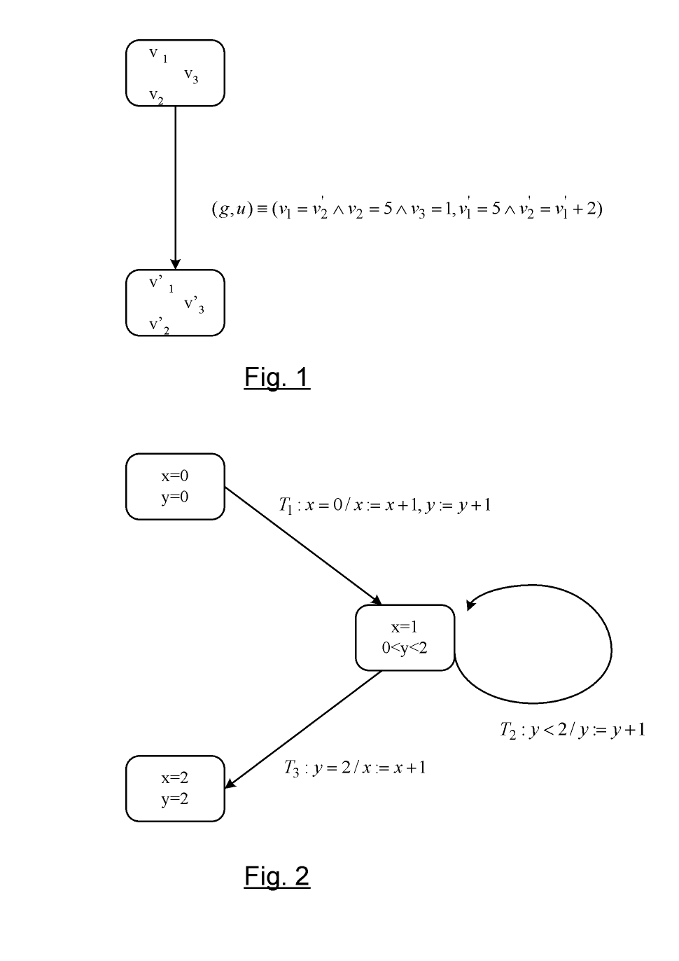

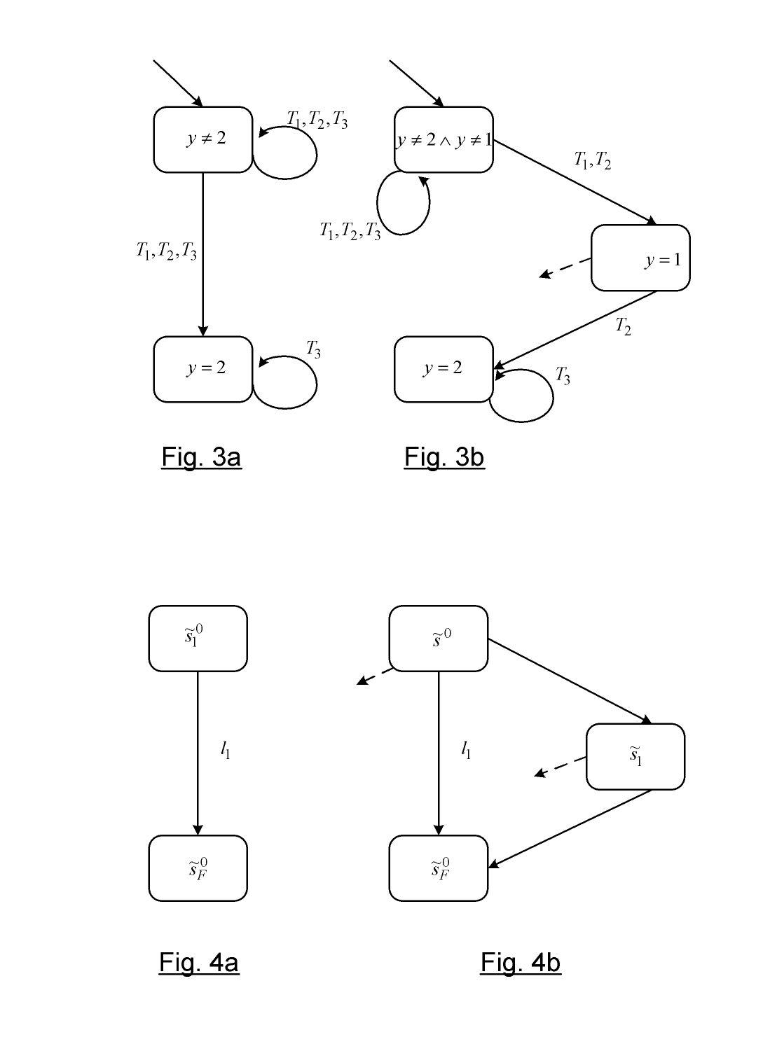

From the fact that {(s, α(s))|sεS} forms a simulation. fsa(α) is thus an existential abstraction of A_{M,F}. For example FIG. 2 shows a transition system, FIG. 3a shows an initial abstraction for FIG. 2, and FIG. 3b is its refinement. From Theorem 1, the following is derived:

For an FSA Ã≧A_{M,F}, the abstract path corresponding to a concrete path s₁, l₁, s₂, l₂, . . . is α(s₁), l₁, α(s₂), l₂, . . . , and if sᵢεF then the corresponding α(s₁)ε\tilde{F}.

For an automation Ã as per definition 5, the following can also be derived Ã≧_{α,β}A_{M,F}.

The following definition (definition 6) can also be determined. In an abstraction Ã, for any triple \tilde{t}= [symbol] \tilde{s}₁l\tilde{s}₂ [symbol] (\tilde{s}₁, s₂ε\tilde{S}, and lε range(λ)):
\tilde{t} is a valid transition if ∃s₁εβ(\tilde{s}₁), s₂εβ(\tilde{s}₂):Tₗ(s₁, s₂);
\tilde{t} is an impossible transition if not ∃s₁εβ(\tilde{s}₁), s₂εβ(\tilde{s}₂):Tₗ(s₁, s₂);
\tilde{t} is an always valid transition if ∀s₁εβ(\tilde{s}₁):∃s₂εβ(\tilde{s}₂):Tₗ(s₁, s₂).

Note that the relation \tilde{δ} includes precisely the set of all valid transitions. The notion of always valid transitions will be useful in a sequel.

To check reachability of a F in the transition system M, a counter-example guided abstraction refinement (CEGAR) based technique is used, particularly in Simulink® models. Algorithm 1, as shown below, illustrates a basic CEGAR approach to check reachability of F in the transition system M. The initial abstraction can be any automation built, as per definition 5, from a partition of the state space.

Algorithm 1

```
Input: M ≡ (V,I,T) a concrete model, F a set of states of M .
Output: (r, τ) a pair, where r is a Boolean and τ is an execution path of M
(\tilde{S}₀, β₀) := a partion of S (that respects F )
Ã₀ := fsa (β₀);
p := 0 ;
while true do
      Ãₚ ≡ (L,\tilde{S}ₚ,Ĩₚ,\tilde{δ}ₚ,\tilde{F});
      σₚ := findpath(Ãₚ);
      if σ = NULL then
            return( false,NULL);
      (b,τ,stp) := checksimulation(M,σₚ,βₚ);
      if b then
            return(true,τ)
      stp ≡ (\tilde{s}_{b},l,\tilde{s}ₑ)
      l* Partitioning,to compute new partition * /
      Sₚ₊₁ := sₚ −{\tilde{s}_{b}} ∪ {\tilde{s}_{b1},\tilde{S}_{b0}};
      βₚ₊₁ := partition (βₚ,stp,\tilde{s}_{b1},\tilde{s}_{b0});
      l * Computing new initial states * /
      if \tilde{s}_{b} ε Ĩₚ then
            Ĩₚ₊₁ := Ĩₚ − {\tilde{S}_{b}};
            if (β_{P+1} (\tilde{S}_{b0})∩I ≠ φ)then Ĩₚ₊₁ :=Ĩₚ₊₁ ∪{\tilde{s}_{b0}};
            else Ĩₚ₊₁ :=Ĩₚ₊₁ ∪{\tilde{s}_{b0}};
      else
            Ĩₚ₊₁ :=Ĩₚ;
      l* Computing new transition relation* /
      \tilde{δ}ₚ₊₁ :=recompute(Ãₚ,M,βₚ₊₁,Sₚ₊₁);
      Ãₚ₊₁ :=(L,\tilde{S}ₚ₊₁Iₚ₊₁,\tilde{δ}ₚ₊₁,\tilde{F});
      p := p+1;
end
```

The steps used in algorithm 1 are described herein. A findpath takes an automata Ã as an argument and returns a derivation σ, which is NULL if there is no derivation of Ã. If there is a derivation of Ã, then σ=\tilde{s}₁, l₁, \tilde{s}₂ . . . , \tilde{s}ₙ such that s₁εĨ, sₙεF, and sᵢε\tilde{F} for i<n. This technique involves only a graph search. The automata Ã is viewed as a graph with its states being nodes, and transitions being edges. The objective is to find and return a path in the graph from a node in Ĩ to a node in \tilde{F}. It should be understood that the set of final states \tilde{F} is the same throughout. This is valid because a path is always chosen that contains a state in \tilde{F} only as a last state.

The next step is a checksimulation which checks if there is a valid finite labeled trace of M (e.g., a path in A_{M, F}) corresponding to a. For σ [symbol] \tilde{s}₁, l₁, \tilde{s}₂ . . . \tilde{s}ₙ (\tilde{s}₁εĨ and \tilde{s}ₙε\tilde{F}), a check made whether there is a trace of M of the form \tilde{s}₁, l₁, \tilde{s}₂, l₂, \tilde{s}ₙ such that ∀1≦i≦n:sᵢεβ(\tilde{s}ᵢ). If there is a trace τ, then the procedure returns [symbol] true, τ, _ [symbol] . If there is no such trace, then the procedure returns [symbol] false, _, [symbol] \tilde{s}ₖ, lₖ, \tilde{s}ₖ₊₁ [symbol] , where k is the smallest index j(1≦j≦n) such that there is no trace of M of the form s₁, l₁, s₂l₂ . . . sⱼ₊₁ with ∀1≦i≦n:sᵢεβ(\tilde{s}ᵢ). The checksimulation as described herein is iteratively shown in the algorithm 2 shown below:

Algorithm 2: Procedure checksimulation

```
Input : M a concrete model, σ an abstract trace
Output : [symbol]   b, τ,stp [symbol]
Let σ[i]= [symbol]  sᵢ,lᵢ,sᵢ + 1 [symbol]   ;
assert(I [symbol]   β (\tilde{s}₁));
i:=1;
while i≦length (σ)−1do;
          assert(step(Tₗᵢ,i−1));
          assert(step(β(\tilde{s}ᵢ₊₁),i)); [symbol]
          b,τ [symbol]   :=check( );
          if [symbol]   b then
              return [symbol]  false,NULL,σ[i] [symbol]
end
return [symbol]   true,τ,NULL [symbol]   ;
```

In Algorithm 2, the assert (P) means the predicate of P is assumed. Routine check( ) indicates whether the predicates that have been assumed as of that point in time are satisfied. For σ as described above, will indicate that there are n−1 iterations, and a number of n calls to a suitable decision procedure.

The predicates that are asserted are drawn from M. It should be understood that variable occurrences in the predicates have to renamed in some manner. For example, if variable υ occurs in β(\tilde{s}₁) and β(\tilde{s}₂), these occurrences correspond to values of υ at different steps, and more particularly, that these values could be connected by the transition predicate Tₗ_{₁}. These predicates are asserted such that distinct occurrences and the connections are accounted for correctly. This is accounted for using a renaming scheme based on indices into the path of interest σ. This is formalized using the function step show at lines 5-6 in the algorithm shown in Algorithm 2.

A next definition (definition 7) is derived. Definition 7 states that xx returns a formula that is the same as xx but with every variable occurrence replaced by an occurrence of the same variable for xx steps further ahead.

It is noted that if a particular [symbol] \tilde{s}ₖ, lₖ, \tilde{s}ₖ₊₁ [symbol] is an always valid transition, that its validity check shown at lines 8-10 in FIG. 2 is unnecessary. Therefore, if this information is known without checking for it and without the overhead of maintaining it, then computation time and power is saved since a decision procedure check is not required. As a result, this is exploited in optimizing the reachability technique.

The next step is a partition which is represented by β [symbol] \tilde{s}_{b}, l, \tilde{s}ₑ) [symbol] \tilde{s}_{b1}, \tilde{s}_{b0}. The partition returns the modified map β′, which is computed as follows:

Pᵣ₁=β(\tilde{s}_{b}) [symbol] Pre(β(\tilde{s}ₑ)Tₗ)

Pᵣ₁=β(\tilde{s}_{b}) [symbol] [symbol] Pre(β(\tilde{s}ₑ)Tₗ)

β′:=β−{\tilde{s}_{b} [symbol] _{—}}∪{\tilde{s}_{b1} [symbol] Pr₁,\tilde{s}_{b0} [symbol] Pr₀}

where

Pre(X,Tₗ) [symbol] step(X,1)ΛTₗ⁴

Pre(X, Tₗ) captures the condition taking the transition Tₗ, the model M can be in some state in X. Then, [symbol] Pre(X, Tₗ) captures the condition taking the transition Tₗ, the model M is guaranteed not to be in some state in X. If model M is deterministic, then Pre is equivalent to the weakest-precondition, i.e., from any state in Pre(X, Tₗ) transition Tₗ is guaranteed to result in a state in X. In general, for the weakest pre-condition WP(X, Tₗ) [symbol] step(X,1) [symbol] Tₗ [symbol] [symbol] (step( [symbol] X,1) [symbol] T)⁵, where the second term takes care of possible non-determinism. If model M is deterministic, then this term will be true, and thus Pre and WP are identical.

A next definition (definition 8) may be derived as follows. New states \tilde{S}_{b1} where Pre with respect to the failed transition is true will be called the true-partition with respect to [symbol] \tilde{s}_{b}, l, \tilde{s}ₑ [symbol] , and the new state \tilde{s}_{b0} where Pre with respect to the failed transition is false will be called the false-partition with respect to [symbol] \tilde{s}_{b}, l, \tilde{s}ₑ [symbol] . It is noted that if an abstract state \tilde{s}εS is the false-partition with respect to some [symbol] \tilde{s}_{b}, l, \tilde{s}ₑ [symbol] , then [symbol] \tilde{s}_{b}, l, \tilde{s}ₑ [symbol] is an impossible transition. Similarly, if an abstract state \tilde{s}ε\tilde{S} the true-partition with respect to some [symbol] \tilde{s}_{b}, l, \tilde{s}ₑ [symbol] and if [symbol] \tilde{s}_{b}, l, \tilde{s}ₑ [symbol] is deterministic, then [symbol] \tilde{s}_{b}, l, \tilde{s}ₑ [symbol] is always a valid transition. It should also be noted that a deterministic M does not mean that the abstract FSAs Ãₚ are deterministic. Rather the FSAs Ã_{P} are invariably non-deterministic.

The next step is a recompute represented by (Ã, M, β′, S′). In a recompute, the routine returns a transition relation δ′ over the new set of abstract states S′. From definition 5, it should be clear that for \tilde{s}₁, \tilde{s}₂εS′, \tilde{δ}′(\tilde{s}₁, l, \tilde{s}₂) [symbol] ∃s₁εβ′(\tilde{s}₁), s₂εβ′(\tilde{s}₂):Tₗ (s₁, s₂). In practice, [symbol] (\tilde{s}₁, l, \tilde{s}₂) [symbol] is added to δ′ whenever Pre(β′(\tilde{s}₂), Tₗ) [symbol] β′(\tilde{s}₁) is unsatisfiable (i.e., if [symbol] (\tilde{s}₁, l, \tilde{s}₂) [symbol] is a valid transition).

The recompute step computes a succession of FSAs Ã₀, Ã₁, . . . , Ãₚ. The following is a possible result obtained for the algorithm. For every (\tilde{S}ₚ, βₚ) produced by algorithm 1 is a partition. That is, by induction of the sequence Ã₀, Ã₁, . . . , Ãₚ . . . , the base case is not true trivially (from line 1 of Algorithm 1). For the induction step, assume (\tilde{S}ₚ, βₚ) is a partition. (\tilde{S}ₚ₊₁) is obtained by partitioning one of the states of \tilde{S}ₚ (lines 13-14 of Algorithm 1) and hence it is also a partition of S.

As a result, the following theorem (3) may be derived: every Ãₚ is produced by algorithm 1 satisfies Ãₚ≧ₐ_{ₚ}_{,β}_{ₚ}Ã_{M,F}, where (\tilde{S}ₚ, βₚ) is a partition of S. Ãₚ is obtained by computing its transition relation as per definition 5. Therefore, from Theorem 2, this is a valid transition.

The following theorem (4) may be derived: Ãₚ≧Ãₚ₊₁, for p≧0; (4) if M is deterministic and its transitions are disjoint; the first part of the theorem may be proved. Consider a map

H⊂Sₚ₊₁×\tilde{S}ₚ [symbol] {(\tilde{s},\tilde{s})|\tilde{s}≠\tilde{s}_{b} [symbol] \tilde{s}·\tilde{s}_{b0} [symbol] \tilde{s}≠\tilde{s}_{b0} [symbol] \tilde{s}≠\tilde{s}_{b1}}∪{\tilde{s}_{b0},\tilde{s}_{b}),(\tilde{s}_{b1},\tilde{s}_{b}).

It is a simulation since for all (\tilde{s}′, \tilde{s})εH, every transition from \tilde{s}′ in Ãₚ₊₁ has a corresponding transition from \tilde{s} in Ãₚ (due to recompute). It is also satisfies the condition of definition 3 (lines 15-20 of Algorithm 1) and hence the results hold.

The second part follows from the fact that there exists no simulation relation H⊂Sₚ₊₁×\tilde{S}ₚ. If M is deterministic and its transitions are disjoint, then for any Ãₚ (p≧1) and for the state sεSₚ that is the true-partition that was introduced in Ãₚ with respect to some [symbol] (\tilde{s}_{b}, l, \tilde{s}ₑ) [symbol] of Ã_{p-1,} then the following are true:
(1) Y has exactly one transition out of it (i.e., |δₚ(\tilde{s}, _, _), and it is [symbol] (\tilde{s}, l, \tilde{s}ₑ) [symbol] .
(2) [symbol] (\tilde{s}_{b}, l, \tilde{s}ₑ) [symbol] is always a valid transition.
(3) s̅ will not be partitioned in any of the FSAs Ãₚ (q≧p).

For any Ãₚ, if the partition is on the first state of the abstract path then, the false-partition will be an initial state in Ãₚ₊₁, and the true-partition will not be partitioned. That is, for σ=\tilde{s}₁, \tilde{s}₂, . . . , sₙ, if the partition is on [symbol] (\tilde{s}, l, \tilde{s}ₑ) [symbol] , then the false partition \tilde{s}₁₀ will be in Ĩₚ₊₁ and the true-partition \tilde{s}₁₁ will not be in Ĩₚ₊₁.

The following is a proof. It is obvious that \tilde{s}₁ is an initial state of Ãₚ₊₁. Assume that \tilde{s}₁₁ is an initial state of Ãₚ₊₁, then from Algorithm 1, lines 17-18, if follows:

I [symbol] βₚ₊₁(\tilde{s}₁₁) is satisfiable;

[symbol]

I [symbol] βₚ(\tilde{s}₁) [symbol] step(βₚ(\tilde{s}₂),1) [symbol] Tₗ is satisfiable.

This implies that the first transition [symbol] \tilde{s}₁, l, \tilde{s}₂ [symbol] of a was valid in M (lines 1-3 and the first iteration of lines 5-9 of Algorithm 2 checks exactly the above condition). However, this contradicts with the fact that the partition happened on this transition and hence it was found to be infeasible. As a result, the assumption is wrong and \tilde{s}₁₁ is not an initial state of Ãₚ₊₁. Therefore, since an initial state \tilde{s}₁ was partitioned to obtain \tilde{s}₁₁ and \tilde{s}₁₀, \tilde{s}₁₀ will be an initial state of Ãₚ₊₁.

FIG. 3a illustrates an initial abstraction, and the aim is find a trace to reach the concrete state satisfying a predicate y=2. The routine findpath ( ) produces an abstract trace σ₀=\tilde{s}₁, T₂, s₂. The routine checksimulation ( ) finds if this is a valid trace in the concrete model. The computations are as follows:

assert(I [symbol] β(\tilde{s}))=x=0 [symbol] y≠2

assert(step(T₂,0))=y<2=0 [symbol] y′=y+1

assert(step(β(\tilde{s}₂),1)=y′=2

Routine check ( ) finds that the above constraints are unsatisfiable. For the refinement, node \tilde{s}₁ is split to produce states \tilde{s}₁₀ and \tilde{s}₁₁.

Pre(β(\tilde{s}₂),T₂)=step(β(\tilde{s}₂),1) [symbol] T₂=y′=2 [symbol] y′=y+1

i.e., Pre(β(\tilde{s}₂), T₂)=y+1
i.e., β(ś₁₁)=y=1 [symbol] y≠2 and β(\tilde{s}₁₀)=≠1 [symbol] y≠2

FIG. 3(b) illustrates a refined model. The routine recompute ( ) computes the transitions of the refined model. In the next iteration, the new abstract trace is σ₀=\tilde{s}₁₀, T₁, s₁₁, T₂, \tilde{s}₂. Thereafter, a checksimulation ( ), performs the following computations:

assert(I [symbol] β(\tilde{s}₁0))=x=0 [symbol] y≠1 [symbol] y≠2

assert(step(T₁,0))=x=0 [symbol] x′=x+1 [symbol] y′=y=+1

assert(step(β(\tilde{s}₁₁),1)=y′=1 [symbol] y′≠2

assert(step(T₂,1))=y′<2 [symbol] y″=y¹+1

assert(step(β(\tilde{s}₂),2)=y″=2

The above assertions are satisfiable, which indicates that a trace to the desired state in the concrete model is found.

In Algorithm 1, the partition used to define the initial abstraction was left unspecified (e.g., line 1). The unspecified partition is corrected and the consequences of the algorithm are derived. The assumptions are that (1) the transition T is deterministic, and (2) a findpath always selects an acrylic path. For a given set of states F, the partition (\tilde{S}⁰, β⁰) is defined as follows:

\tilde{S}⁰={s_{I}⁻⁰,s_{F}⁻⁰}

β⁰(s_{I}⁻⁰) [symbol] [symbol] F,

β⁰=(s_{F}⁻⁰)F

### That is,

$${α}^{0} ( s ) = \{ \begin{matrix}{s}_{I}^{- 0} & if s ∉ F \\ {s}_{F}^{- 0} & if s ∈ F\end{matrix} \} .$$

An existential abstraction fsa(α⁰) is obtained by applying the following definition to the partition (\tilde{S}⁰, β⁰). The following is a result from Theorem (2):

fsa(α⁰)≧_{α}_{⁰}_{,β}_{⁰}Ã_{M,F}.

Algorithm 1 is considered (\tilde{S}⁰, α⁰) with as the initial partition at line 1. A number of observations can be made regarding the FSAs Ãₚ computed by the algorithm. These observations are analyzed as follows:

Algorithm 1 is applied with the model fsa(α⁰) as Ã₀. Then in the first iteration of the loop (p=0), a path σ₀ (if it exists) will be of the form s_{I}⁻⁰, l₁, s_{F}⁰ as shown in FIG. 4a. If this is infeasible, then the start state of σ₀ will be partitioned (i.e., the initial state s_{I}⁻⁰. This will provide two new states, a false partition \tilde{s}₀ and a true-partition \tilde{s}₁. \tilde{s}₀ will become the new initial state. \tilde{s}₁ will have only a single transition out of it, namely s_{I}⁻⁰, l₁, s_{F}⁻⁰, and this will always be valid in M. As a result, this generates a new FSA Ã₁, in which there are two kinds of acrylic paths possible to s_{F}⁻⁰ as shown in FIG. 4b, \tilde{s}₀, l₂, \tilde{s}₁, l₂, s_{F}⁰ or \tilde{s}₀, l₃, s_{F}⁻⁰ (for some l₂, l₃). In both instances, the start state (and initial state) \tilde{s}₀ will be partitioned in case the path is infeasible, and the new initial state (of Ã₂) will again be the false-partition while the true-partition will have a single valid transition out (i.e., that either to s_{F}⁻⁰ or to the other true-partition state \tilde{s}₁). The models Ãₚ all have initial and final state sets as singletons, and that the refinement always happens on the start state of an acyclic path (that is also the initial state). Ãₚ also has the property that all the states apart from the initial and final states are true-partitions. The validity of the acrylic path is checked and only the first transition has to be checked.

In Theorem (5), the assumption is for any Ãₚ, Ĩₚ, and \tilde{F}ₚ are singletons. This can proved by induction sequence Ã₀, . . . , Ãₚ. The base case p=0 is trivially true from construction of (\tilde{S}⁰, α⁰). Consider an induction step. Assume that the result holds for Ãₚ. Then Ãₚ₊₁ is obtained by partitioning exactly one state \tilde{s}_{b} (into true-partition \tilde{s}_{b1} and false-partition \tilde{s}_{b0}) of Ãₚ to get \tilde{S}ₚ₊₁, βₚ₊₁. If \tilde{s}_{b} is not the initial state of Ãₚ, then neither of the new states is an initial state (lines 15-20 of Algorithm 1), and hence the result holds of Ãₚ₊₁ If \tilde{s}_{b} is the initial state of Ã_{p′}, and since only acyclic paths are chosen and since \tilde{s}_{b} is the only initial state of Ã_{p′}, then \tilde{s}_{b} is the first state on the abstract path σₚ. It is clear that only the false-partition \tilde{s}_{b0} will be an initial state of Ãₚ₊₁ and thus Ĩₚ₊₁ is a singleton. Regarding the final state, since Ãₚ has only one final state, this will necessarily occur as the last state on the path σₚ, and will never be split. Therefore, Ãₚ₊₁ will have the same unique final state as Ãₚ. The result holds for Ãₚ₊₁.

In going forward, the state of Ãₚ will only be referred to as ĩₚ, while only the final state will be \tilde{s}_{F}⁰ (since it was shown above that the final state of Ãₚ₊₁, is the same unique final state as Ãₚ, and the final state is Ã⁰'S final state.

Theorem (6) states that for any Ãₚ, each non-initial non-final abstract states corresponds to a true-position (introduced in some Ã_{q}, 1≦q≦p). This can be proved by induction on the sequence Ã₀, . . . , Ãₚ . . . . The base case (p=0) is trivially true from construction of) (\tilde{S}⁰, α⁰), which has no non-initial non-final states. Consider an induction step. Assume that the result holds for Ãₚ A. Then from the assumption (theorem 5), we also know that the σₚ has a unique initial state ĩₚ and a unique final state s_{F}⁻⁰. Then any acyclic path σₚ that we choose in Algorithm 1 begins with ĩₚ, ends with s_{F}⁻⁰, and has all intermediate states (if any) as true-partition states. It is readily understood that all transitions in σₚ except the first are always valid transitions. This means that if σₚ is infeasible, then it is because of the next transition (i.e., this is what checksimulation will return as stp) and hence the portioning will happen on the start state ĩₚ. It is clear that among the new states, the false-partition will become the new initial state (of Ãₚ₊₁). The result holds for Ãₚ₊₁.

In both the above proofs, the induction step will go through regardless of what the initial abstraction was (it requires only deterministic M). This means that any initial partition that has the above properties will suffice. The simplest partition is selected.

Theorem (7) states that for any acyclic path σₚ in Ãₚ, all the transitions except the first are always valid transitions.

Theorem (8) states that for any Ãₚ and any acyclic path σₚ, the partitioning, if any, will happen on ĩₚ and moreover as the first abstract state of σ_{P}. This is proved in that partition will be on ĩₚ is a corollary of Theorem 7. For acyclic paths σₚ, the unique initial state ĩₚ occurs only as the first state on the path (from Theorem 5). Therefore, ĩₚ since will be partitioned, the partition is always on the first state for acyclic σₚ.

Based on the above results, the following improvements are possible for the algorithm.

Improvement (A): based on theorem 6, Ãₚ only needs to choose a non-loop edge out of the node corresponding to ĩₚ in the graph corresponding to Ãₚ. The rest of the path is uniquely determined. This simplifies findpath.

Improvement (B): from theorem 8, the recomputation of initial state after partition is trivial, and is always a false-partition. This means lines 15-20 of Algorithm 1 can be replaced by a single assignment, and this saves a decision procedure call (at line 17).

Improvement (C): from theorem 7, it is clear that checksimulation (8xx) needs to check the validity of only the first transition of σₚ. This means that a number of decision procedure check calls from length σₚ to 1 can be reduced. This should result in significant performance improvements in practice, since the decision procedure checks are always the most expensive part of the algorithm.

Algorithm 3 provides a revised version of the basic algorithm given earlier as Algorithm 1 incorporating improvements as described above. Algorithm 3 is as follows:

Algorithm 3: CEGAR based reachability - revision 1

```
Input : M a concrete model, F a set of states of M
Output :(r,τ) a pair, where r is a boolean and τ is an execution path of M
Ã₀ := fsa(α⁰);
p:=0;
while true do
          Ãₚ ≡ (L,\tilde{S}ₚ,{\tilde{ι}ₚ},{\tilde{s}_{F}⁰});
          σₚ := findpath_1(Ãₚ);
          if σₚ := NULL then
              return (false,NULL) [symbol]
          b,τ [symbol]   :=checksimulation_1(M,σₚ,βₚ);
          if b then
              return (true,τ)
          stp≡Then first transition of σₚ,say [symbol]   \tilde{s}_{b},l,\tilde{s}ₑ [symbol]   ;
          \tilde{S}_{P+1} := \tilde{S}ₚ −{\tilde{s}_{b}}∪{\tilde{s}_{b1},\tilde{s}_{b0}};
          β_{P+1} := partition(βₚ,stp,\tilde{s}_{b1},\tilde{s}_{b0});
          Ĩ_{P+1} := Ĩₚ −{\tilde{s}_{b}}∪{\tilde{s}_{b0}};
          \tilde{δ}_{P+1} := recompute(Ãₚ,M,βₚ₊₁,Sₚ₊₁);
          Ã_{P+1} := (L, \tilde{S}ₚ₊₁,Ĩₚ₊₁,\tilde{δ}ₚ₊₁,\tilde{F});
          p:= p + 1;
end
```

The process starts with the abstraction fsa(α⁰). The process uses the procedure findpath_{—}1 (Algorithm 4) revised from findpath as per improvement (A). Algorithm 4 is as follows:

Algorithm 4: Procedure findpath_1

Input : Ã is FSA
Output :σ a path (derivation) of Ã
Ã ≡ (L,S,{\tilde{ι}},δ,{\tilde{s}_{F}⁰};
/* choose a transition out of the initial state
e := [symbol] \tilde{ι},l,\tilde{s} [symbol] s.t., (s ≠ \tilde{ι}) if it exists;else NULL;
If e = NULL, then
return NULL
σ :=[e]
/* extend the path to the final state
x = \tilde{s};
while x ≠ \tilde{s}_{F}⁰ do
σ := σ. [symbol] x, _, y [symbol] ;
x:=y;
end
return σ;

Algorithm 5 describes a procedure checksimulation_{—}1 (revised from algorithm 2) incorporating the improvement from Improvement (C). Finally as per Improvement (B), the re-computation of the initial state is simplified (i.e., line 14). The procedure partition and recomputed remain unchanged from earlier. Algorithm 5 is as follows:

Algorithm 5: Procedure checksimulation_1

```
Input : M a concrete model,σ an abstract trace
Output : [symbol]   b,τ [symbol]
Let σ[i]≡ [symbol]   \tilde{s}ᵢlᵢ\tilde{s}ᵢ₊₁ [symbol]   ;
assert (I [symbol]   β(\tilde{s}₁) [symbol]   Tₗ );
assert (step(β(\tilde{s}₂),1)); [symbol]
b,τ [symbol]   :=check ( );
if [symbol]   b then
          return [symbol]   false,NULL [symbol]
          /*The rest of σ will be valid,with τ as witness.*/
return [symbol]   true,τ [symbol]   ;
```

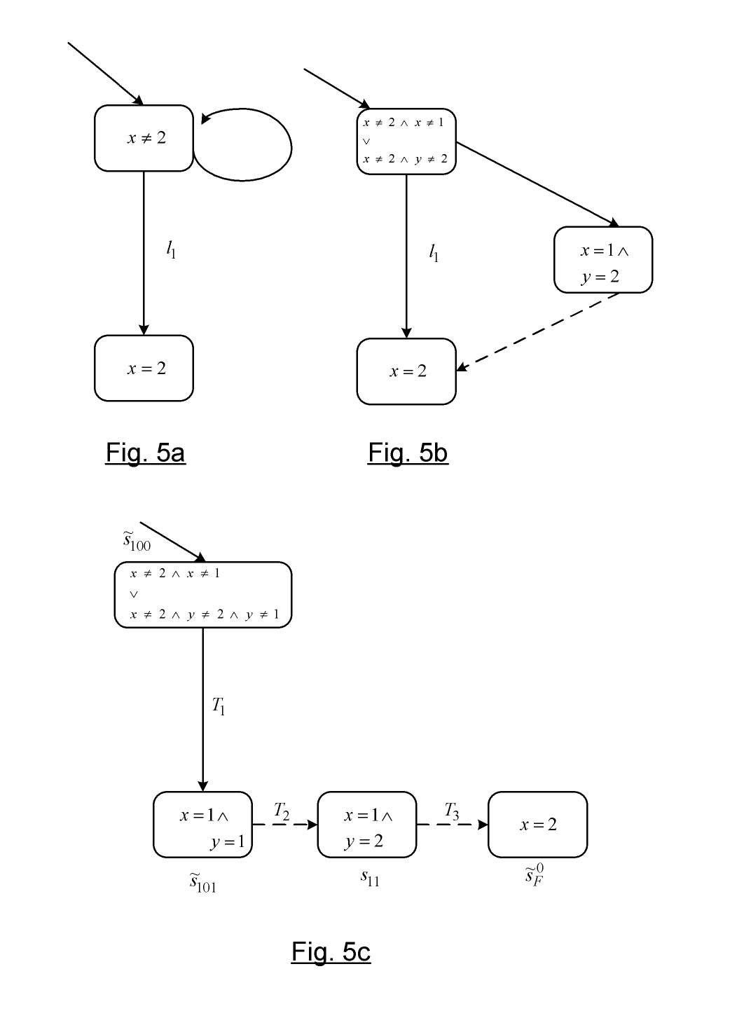

In reference to FIG. 5 which is a two-state abstraction of the transition system in FIG. 2, the final state is \tilde{s}_{F}⁰ with predicate x=2 and the initial state \tilde{s}₁ is denoted by predicate x≠2 as shown in FIG. 5a. The abstract trace to reach the final state is [symbol] \tilde{s}₁, T₃, \tilde{s}_{F}⁰ [symbol] . This is not satisfiable in the concrete since the transition [symbol] T₃ [symbol] cannot go from x≠2 to x=2 in the concrete. FIG. 5b is the abstract model obtained by refinement (i.e., the initial state \tilde{s}₁ is spit to produce \tilde{s}₁₁ and \tilde{s}₁₀). The transition from \tilde{s}₁₁ to \tilde{s}_{F}⁰ is an always valid transition. Next findpath_{—}1 determines the abstract trace as * is the abstract transition to reach the final state. Since the first transition in this trace is unsatisfiable in the concrete, it implies that the whole trace is unsatisfiable. Hence the initial state \tilde{s}₁₀ is split to produce the new states \tilde{s}₁₀₁ and \tilde{s}₁₀₀, and the abstraction is shown in FIG. 5c. Findpath_{—}1 finds the new abstract trace as: [symbol] s₁₀₀, T₁, \tilde{s}₁₀₁, T₂, \tilde{s}₁₁, T₃, \tilde{s}_{F}⁰ [symbol] . Since the first transition of this abstract trace is satisfiable in the concrete it implies that the whole abstract trace is satisfiable in the concrete.

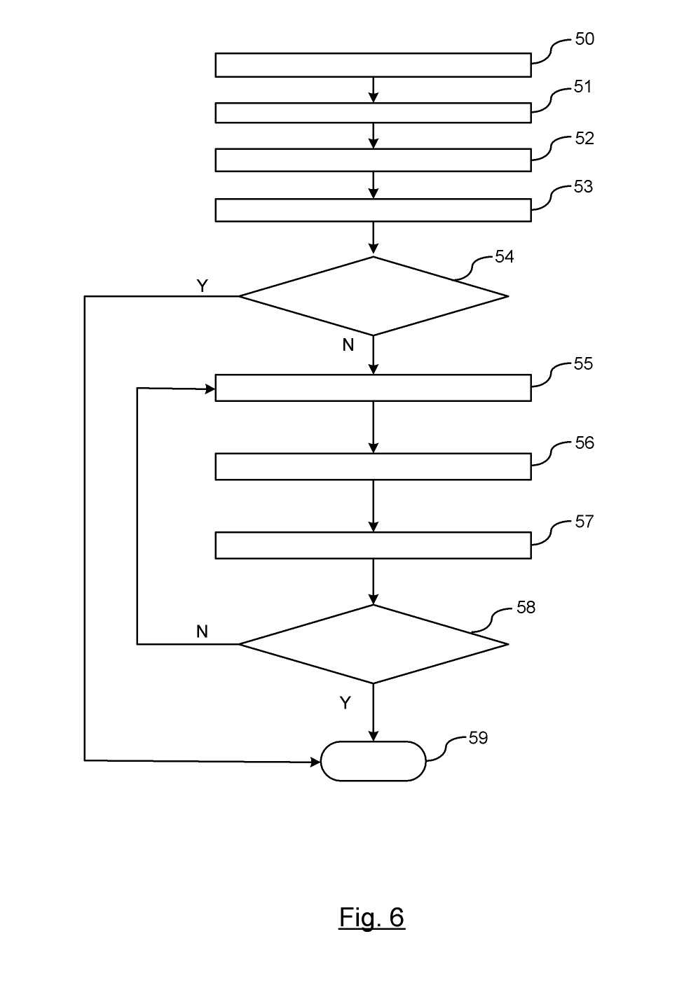

FIG. 6 illustrates a flowchart for determining a reachability of transition system models utilizing an enhanced partition refinement approach.

In step 50, a Simulink/Stateflow® (SL/SF) concrete model is generated for a respective system or subsystem of a vehicle.

In step 51, an abstract model is generated.

In step 52, an abstract path is determined in the abstract model. The abstract path is a sequence of steps from a source abstract state to a target abstract state via a respective transition. This is referred to as a findpath technique.

In step 53, a validity check is performed on the abstract path in the concrete model. If the abstract path is determined to be invalid, then the routine proceeds to step 55. If the abstract path is determined to be valid, then the routine proceeds to step 59 to determine if the abstract path is infeasible from the initial condition.

In step 55, if abstract path was found to be invalid, then the source state associated with the invalid abstract path is partitioned.

In step 56, a new abstract model is recomputed. Recomputing the abstract model includes determining whether each transition out of the abstract state in the current abstract model will be feasible in and out of the partitioned states of the next abstract model. This involves the use of a solver processor such as a Satisfiably Modulo Theory solver for determining a validity of each transition.

In step 57, a next abstract path is generated for the next abstract model.

In step 58, a determination is made whether the abstract path in the concrete model is valid. If the determination is made that the abstract path in the concrete model is valid, then the routine proceeds to step 59. If the determination is made that the abstract path is invalid, then a return is made to step 55 to partition the current source state.

In step 59, the routine ends as a valid path is found from the initial state to the target state. The result is output to a user that identifies whether the recomputed abstract path is a valid result for testing the concrete model in a vehicle system.

While certain embodiments of the present invention have been described in detail, those familiar with the art to which this invention relates will recognize various alternative designs and embodiments for practicing the invention as defined by the following claims.

What is claimed is:

1. A method for verifying reachability of a transition path between states with respect to Simulink/Stateflow® models, the method comprising the steps of:
(a) generating a concrete simulation model as a transition system by a processor;
(b) generating an abstract model by the processor;
(c) generating an abstract path by the processor that is a sequence of transition steps from a start state to a target state;
(d) checking a validity of the abstract path by the processor utilizing the concrete simulation model;
(e) outputting a result to a user by an output device that identifies the abstract path as a reachable result; otherwise proceeding to step (f);
(f) partitioning a respective state of the transition step that was invalid in the abstract path by the processor;
(g) recomputing a next abstract model by the processor based on partitioned start state in step (f);
(h) generating an next abstract path by the processor;
(i) determining whether the next abstract path is valid in the concrete model by the processor;
(j) outputting a result to the user by the output device that identifies whether the recomputed abstract path is a valid result for testing the concrete model in a vehicle system; otherwise proceeding to step (f).

2. The method of claim 1 wherein the start state is a current source state of a current abstract model.

3. The method of claim 2 wherein only the abstract paths having a length less than a threshold are generated to check the validity.

4. The method of claim 2 wherein all paths are generated to check validity between the source state and the target state.

5. The method of claim 4 wherein all paths generated are acyclic paths.

6. The method of claim 1 wherein the simulation model is a SL/SF model.

7. The method of claim 1 wherein partitioning a respective state is based on a pre-image of the respective state with respect to the transition step.

8. The method of claim 1 wherein a set of abstract states in an abstract model is a partition of concrete state in the concrete simulation model.

9. The method of claim 1 wherein the concrete model and transition paths are tested in a vehicle wiring harness for determining validity of input and output responses.

10. The method of claim 1 wherein the concrete model and transition paths are implemented in a vehicle.

11. The method of claim 1 wherein step (g) includes a processor determining whether each transition out of the abstract state in the current abstract model will be feasible in and out of the partitioned states of the next abstract model.

12. The method of claim 11 wherein the processor is a solver.

13. The method of claim 12 wherein the solver is a Satisfiably Modulo Theory solver.
